(19) United States
(12) Patent Application Publication
(10) Pub. No.: US 2025/0162335 A1
(43) Pub. Date: May 22, 2025

(54) PRINTING APPARATUS

(71) Applicant: SEIKO EPSON CORPORATION, Tokyo (JP)

(72) Inventor: Shoji Akatsu, SHIOJIRI-SHI (JP)

(21) Appl. No.: 18/952,389

(22) Filed: Nov. 19, 2024

(30) Foreign Application Priority Data
Nov. 20, 2023 (JP) 2023-196713

(51) Int. Cl. B41J 29/02; B41J 11/02; B41J 15/02

(52) U.S. Cl. CPC B41J 29/02; B41J 11/02; B41J 15/02

(57) ABSTRACT

A printing apparatus includes a printing unit that performs printing on a medium while moving in a movement direction, a platen that is provided at a position facing the printing unit in a printing range of the printing unit and supports the medium, a base frame that extends in the movement direction and supports the platen, and a pair of leg frames that is provided with an interval therebetween in the movement direction and supports the base frame. The base frame includes an protruding portion that protrudes further to the outer side than the leg frame in the movement direction, and the protruding portion includes a reinforcing portion in which a plurality of metal plates overlap each other when viewed from a direction intersecting the movement direction.

The present application is based on, and claims priority from JP Application Serial Number 2023-196713, filed Nov. 20, 2023, the disclosure of which is hereby incorporated by reference herein in its entirety.

### BACKGROUND

### 1. Technical Field

The present disclosure relates to a printing apparatus.

### 2. Related Art

Hitherto, various types of printing apparatus have been used. Among them, there is a printing apparatus including a printing unit, a platen that supports a medium at a position facing the printing unit, and a base frame that supports the platen. For example, JP-A-2021-59073 discloses a printing apparatus including a discharge head as a printing unit that performs printing by reciprocating scanning, a platen, a base frame, and a pair of leg frames. In the printing apparatus, the base frame extends to the outer side of the leg frame in a reciprocating scanning direction of the discharge head.

In a configuration including a so-called protruding portion in which a base frame extends to the outer side of a leg frame in a movement direction of a printing unit, as in the printing apparatus disclosed in JP-A-2021-59073, the protruding portion is likely to be deformed. Thus, in JP-A-2021-59073, for example, a triangular reinforcing member (a so-called corbel member) is installed at the leg frame in order to reinforce the base frame. However, when the triangular reinforcing member is installed at the leg frame, a space for installing the triangular reinforcing member cannot be effectively utilized.

### SUMMARY

In order to solve the problem described above, a printing apparatus according to the present disclosure includes a printing unit configured to perform printing on a medium while moving in a movement direction, a platen provided at a position facing the printing unit in a printing range of the printing unit and configured to support the medium, a base frame extending in the movement direction and configured to support the platen, and a pair of leg frames provided with an interval therebetween in the movement direction and configured to support the base frame. The base frame includes a protruding portion protruding further to an outer side than the leg frame in the movement direction, and the protruding portion includes a reinforcing portion constituted by a plurality of metal plates overlapping each other when viewed from a direction intersecting the movement direction.

### BRIEF DESCRIPTION OF THE DRAWINGS

FIG. 1 is a schematic side cross-sectional view of a printing apparatus according to an embodiment of the present disclosure.

FIG. 2 is a perspective view of the printing apparatus in FIG. 1.

FIG. 3 is a perspective view illustrating a state in which a plurality of constituent members are removed from the state illustrated in FIG. 2.

FIG. 4 is a perspective view illustrating a state in which a plurality of constituent members are further removed from the state illustrated in FIG. 3.

FIG. 5 is a perspective view illustrating the periphery of a protruding portion of the printing apparatus in FIG. 1.

FIG. 6 is a perspective view illustrating the periphery of the protruding portion of the printing apparatus in FIG. 1, when viewed from an angle different from that in FIG. 5.

FIG. 7 is a perspective view illustrating a state in which a constituent member is removed from the protruding portion in the state illustrated in FIG. 6.

FIG. 8 is a perspective view illustrating a state in which a constituent member is further removed from the protruding portion in the state illustrated in FIG. 7.

FIG. 9 is a perspective view illustrating a state in which a constituent member is further removed from the protruding portion in the state illustrated in FIG. 8.

FIG. 10 is a perspective view illustrating a state in which a constituent member is further removed from the protruding portion in the state illustrated in FIG. 9.

FIG. 11 is a perspective view illustrating a state in which a constituent member is further removed from the protruding portion in the state illustrated in FIG. 10.

FIG. 12 is a perspective view illustrating a state in which a constituent member is further removed from the protruding portion in the state illustrated in FIG. 11.

FIG. 13 is a perspective view illustrating the periphery of the protruding portion and an ink supply unit of the printing apparatus in FIG. 1.

### DESCRIPTION OF EMBODIMENTS

First, an overview of the present disclosure will be described.

In order to solve the problem described above, a printing apparatus according to a first aspect of the present disclosure includes a printing unit configured to perform printing on a medium while moving in a movement direction, a platen provided at a position facing the printing unit in a printing range of the printing unit and configured to support the medium, a base frame extending in the movement direction and configured to support the platen, and a pair of leg frames provided with an interval therebetween in the movement direction and configured to support the base frame. The base frame includes a protruding portion protruding further to an outer side than the leg frame in the movement direction, and the protruding portion includes a reinforcing portion constituted by a plurality of metal plates overlapping each other when viewed from a direction intersecting the movement direction.

According to the first aspect, the protruding portion includes the reinforcing portion constituted by the plurality of metal plates overlapping each other when viewed from the direction intersecting the movement direction. With such a configuration, it is possible to eliminate the necessity of providing a new constituent member in the periphery of the leg frame. For example, it becomes unnecessary to install a reinforcing member at the leg frame. Therefore, a space such as a space below the protruding portion can be effectively utilized, and further, the base frame including the protruding portion can be reinforced.

In a printing apparatus according to a second aspect of the present disclosure, the second aspect being an aspect dependent on the first aspect, a shape of the protruding portion on an inner side of the reinforcing portion in the movement direction is different from a shape of the protruding portion on an outer side of the reinforcing portion in the movement direction.

According to the second aspect, the shape of the protruding portion on the inner side of the reinforcing portion in the movement direction is different from the shape of the protruding portion on the outer side of the reinforcing portion in the movement direction. By causing the shape of the protruding portion to be different on the inner side and on the outer side of the reinforcing portion, the space can be effectively utilized in accordance with the shape and the like of the other constituent members.

In a printing apparatus according to a third aspect of the present disclosure, the third aspect being an aspect dependent on the second aspect, the protruding portion has a spatial shape forming a space obtained by cutting out a lower portion of the protruding portion in an upward direction, the spatial shape being located on an outer side of the reinforcing portion in the movement direction.

According to the third aspect, the protruding portion has the spatial shape forming the space obtained by cutting out the lower portion of the protruding portion in the upward direction, and the spatial shape is located on an outer side of the reinforcing portion in the movement direction. Thus, a wide space can be secured below the protruding portion, and the space can be particularly efficiently utilized in accordance with the shape or the like of the other constituent members.

In a printing apparatus according to a fourth aspect of the present disclosure, the fourth aspect being an aspect dependent on any one of the first to third aspects, the protruding portion is constituted by joining the plurality of metal plates in the movement direction.

According to the fourth aspect, the protruding portion is constituted by joining the plurality of metal plates in the movement direction. With such a configuration, the reinforcing portion can be constituted without any increase in size. Thus, the space such as the space below the protruding portion can be effectively utilized.

In a printing apparatus according to a fifth aspect of the present disclosure, the fifth aspect being an aspect dependent on any one of the first to third aspects, the pair of leg frames are provided at positions sandwiching the platen when viewed from a direction intersecting the movement direction.

According to the fifth aspect, the pair of leg frames are provided at the positions sandwiching the platen when viewed from the direction intersecting the movement direction. With such a configuration, the entire printing apparatus can be suitably supported by the pair of leg frames.

A printing apparatus according to a sixth aspect of the present disclosure, the sixth aspect being an aspect dependent on any one of the first to third aspects, includes a maintenance unit configured to perform maintenance of the printing unit, and the maintenance unit is disposed at the protruding portion.

According to the sixth aspect, the maintenance unit is disposed at the protruding portion. With such a configuration, the space of the printing apparatus can be effectively utilized, and it is possible to suppress an increase in the size of the printing apparatus.

In a printing apparatus according to a seventh aspect of the present disclosure, the seventh aspect being an aspect dependent on any one of the first to third aspects, the protruding portion includes a plurality of the reinforcing portions.

According to the seventh aspect, the protruding portion includes the plurality of reinforcing portions. Thus, the base frame including the protruding portion can be effectively reinforced.

In a printing apparatus according to an eighth aspect of the present disclosure, the eighth aspect being an aspect dependent on the seventh aspect, the plurality of metal plates overlap each other in different directions in at least two of the plurality of reinforcing portions.

According to the eighth aspect, the plurality of metal plates overlap each other in different directions in at least two of the plurality of reinforcing portions. With such a configuration, it is possible to reinforce the base frame against stress or the like applied from a plurality of different directions, and the base frame 100 including the protruding portion 110 can be particularly effectively reinforced.

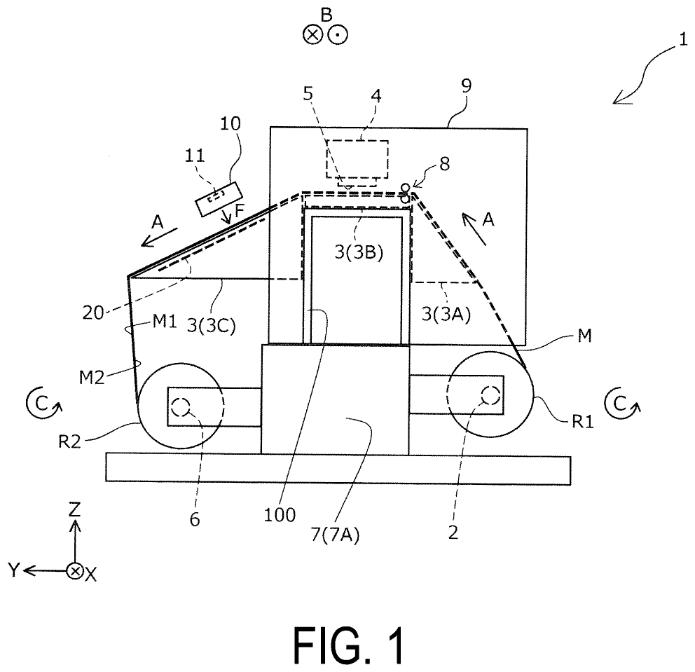

Hereinafter, an embodiment according to the present disclosure will be described in detail with reference to the accompanying drawings. First, mainly referring to FIG. 1, an overview of a printing apparatus 1 according to an embodiment of the present disclosure will be described. Note that, in FIG. 1, some constituent members are simplified and omitted for easy understanding of the configuration. Here, in the accompanying drawings, an X-axis direction is a horizontal direction and a direction in which a support portion of a holding unit 2 extends. The holding unit 2 holds a roll body R1 obtained by winding a medium M into a roll shape. A Y-axis direction is a horizontal direction, the front-rear direction of the printing apparatus 1, and a direction orthogonal to the X-axis direction. A Z-axis direction is a vertical direction. Further, hereinafter, it is assumed that an arrow direction is a + direction, and a direction opposite to the arrow direction is a − direction. For example, it is assumed that a vertically upward direction is a +Z-direction, a vertically downward direction is a −Z-direction, the forward direction of the printing apparatus 1 is a +Y-direction, and the rearward direction of the printing apparatus 1 is a −Y-direction.

The printing apparatus 1 of the embodiment includes a main body unit 9 including a base frame 100, which will be described later in detail. A leg frame 7 is attached to the main body unit 9, in the vicinity of an end portion in the X-axis direction thereof, or at a position further to the inner side than the vicinity of the end portion. Further, the printing apparatus 1 according to the embodiment includes the holding unit 2, which holds the roll body R1 obtained by winding the medium M into the roll shape, on the −Y direction side corresponding to the rear side of the main body unit 9. The holding unit 2 serves as a feeding unit that feeds the medium M from the roll body R1 to the main body unit 9.

In the printing apparatus 1 according to the embodiment, when the medium M is transported in a transport direction A, the holding unit 2, which serves as a rotating shaft along the X-axis direction, rotates in a rotating direction C. The holding unit 2 is a member to be inserted into a paper core as a winding core of the roll body R1. Note that, in FIG. 1, the roll body R1 wound so that an image forming surface M1 on which an image is formed faces outward is used, but when the roll body R1 wound so that the image forming surface M1 faces inward is used, the holding unit 2 can rotate in a direction opposite to the rotating direction C to feed the medium M from the roll body R1.

Further, the printing apparatus 1 according to the embodiment includes a transport path of the medium M. The transport path is constituted by a medium support portion 3 that supports the medium M, and the like. The printing apparatus 1 according to the embodiment includes, as the medium support portion 3, an upstream medium support portion 3A, a platen 3B, and a downstream medium support portion 3C from the upstream to the downstream in the transport direction A. Further, the printing apparatus 1 further includes a roller pair 8 including a driving roller and a driven roller, as a transport unit for transporting the medium M in the transport direction A on the transport path. However, the configuration of the transport unit is not particularly limited.

Further, the printing apparatus 1 according to the embodiment includes a head 5 and a carriage 4, each of which is provided at a position facing the platen 3B. The head 5 serves as a printing unit that is provided with a plurality of nozzles and forms an image by ejecting ink from the nozzles. The carriage 4 is mounted with the head 5 and is reciprocally movable in a width direction B. Note that, in the printing apparatus 1 according to the embodiment, the transport direction A at a position facing the head 5 on the platen 3B is the +Y direction, the width direction B, which is the movement direction of the head 5, is a direction along the X-axis direction, and the ejecting direction of ink is the −Z direction.

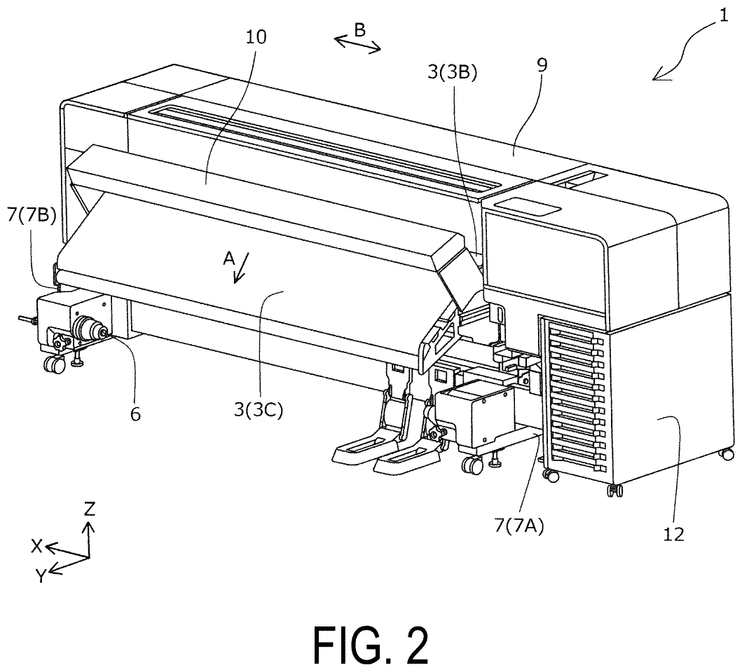

With the configuration described above, the head 5 can form an image by ejecting ink from the nozzles (not illustrated) onto the transported medium M, while the head 5 reciprocates in the width direction B, which is a direction intersecting the transport direction A. The printing apparatus 1 according to the embodiment is configured to form a desired image on the medium M by repeating transport of the medium M by a predetermined transport amount in the transport direction A, and ejection of ink while moving the head 5 in the width direction B in a state in which the medium M is stopped. Note that, as illustrated in FIG. 2, an ink supply unit 12, to which a plurality of ink cartridges each containing ink can be attached, can be disposed on the −X direction side of the main body unit 9, and the ink can be supplied to the head 5 from the ink cartridges attached to the ink supply unit 12.

Further, of the medium support portions 3, the downstream medium support portion 3C is provided with a heater 20 that serves as a heating unit for heating a supported surface M2 on the opposite side to the image forming surface M1 of the medium M. The heater 20 according to the embodiment is constituted by an electric heating wire and the like, but the configuration of the heater 20 is not limited to such a configuration. Further, not only the downstream medium support portion 3C but also the upstream medium support portion 3A or the platen 3B may be provided with a medium heating unit that heats the supported surface M2 on the opposite side to the image forming surface M1 of the medium M.

Further, a drying unit 10 that dries the ink ejected from the head 5 to the image forming surface M1 of the medium M by blowing an airflow F against the image forming surface M1 is provided at a portion facing the downstream medium support portion 3C in the transport path. The drying unit 10 according to the embodiment includes a fan 11 that generates the airflow F and can blow a gas as the airflow F against the image forming surface M1 of the medium M, but the configuration of the drying unit 10 is not limited to such a configuration.

Further, a holding unit 6 is provided downstream of the downstream medium support portion 3C in the transport direction A. The holding unit 6 serves as a winding unit that winds the medium M transported in the transport direction A into a roll shape to obtain a roll body R2. Note that, in the printing apparatus 1 according to the embodiment, the holding unit 2 and the holding unit 6 have the same configuration, and the holding unit 6 rotates in the rotating direction C. The holding unit 6 is a member to be inserted into a paper core as a winding core of the roll body R2. In FIG. 1, when the holding unit 6 rotates in the rotating direction C, the medium M is wound so that the image forming surface M1 faces outward. However, the medium M may be wound so that the image forming surface M1 faces inward. In the latter case, the holding unit 6 rotates in the direction opposite to the rotating direction C.

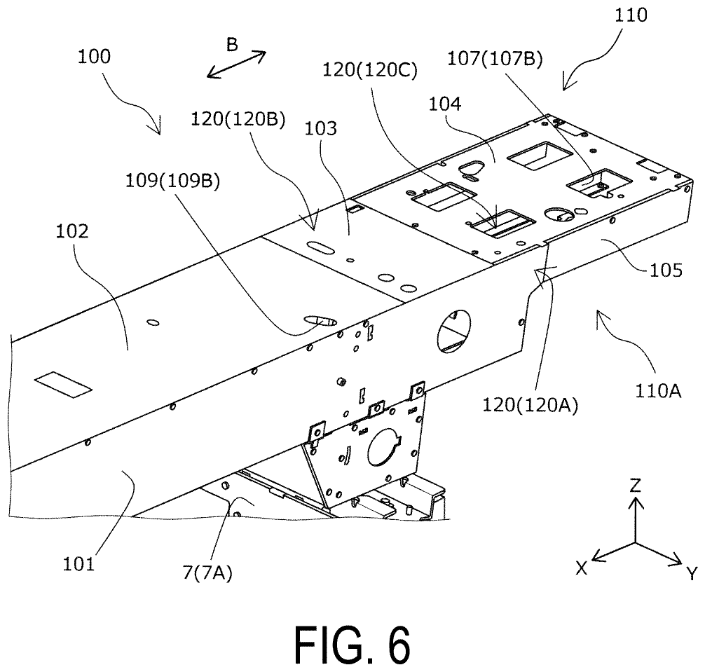

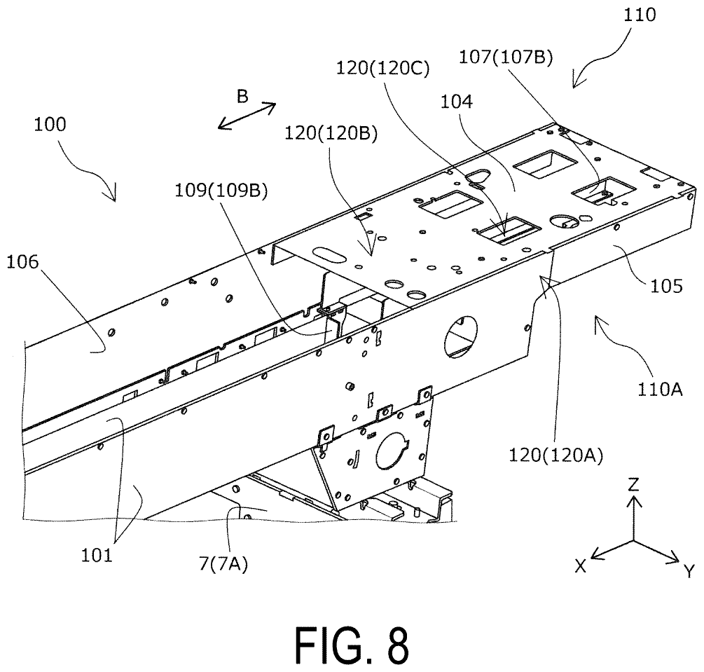

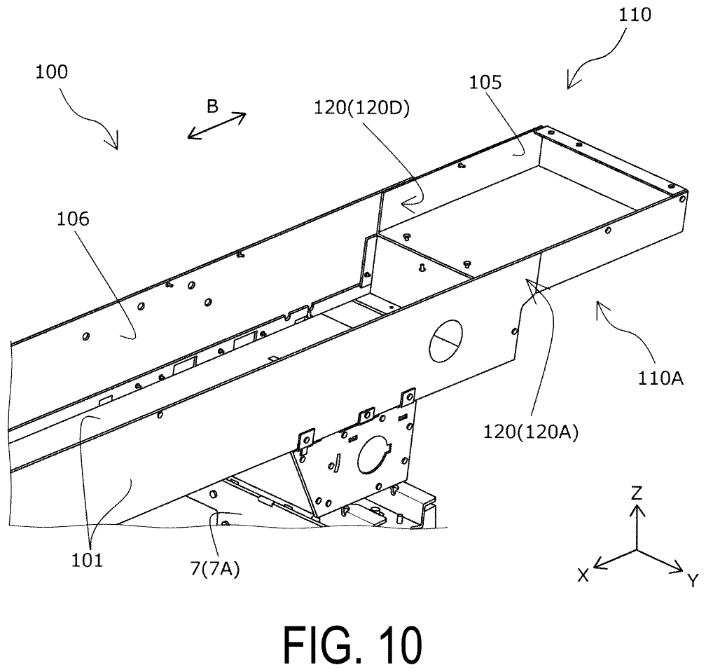

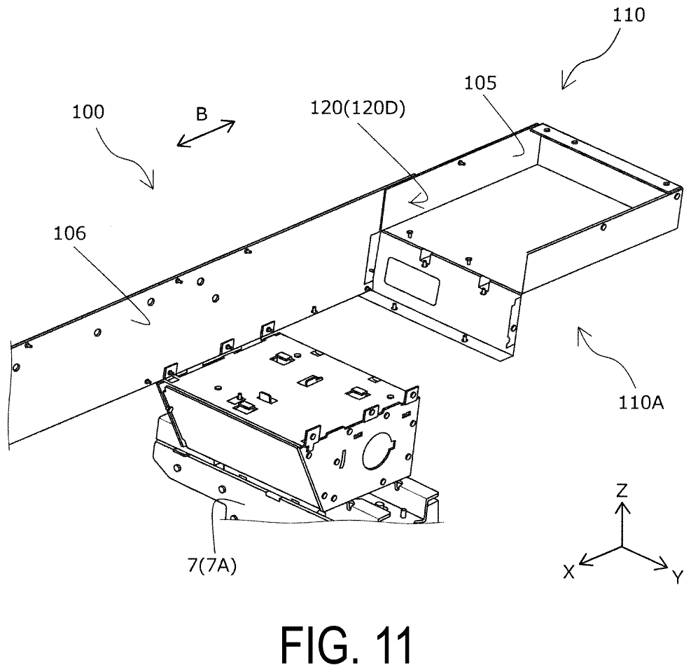

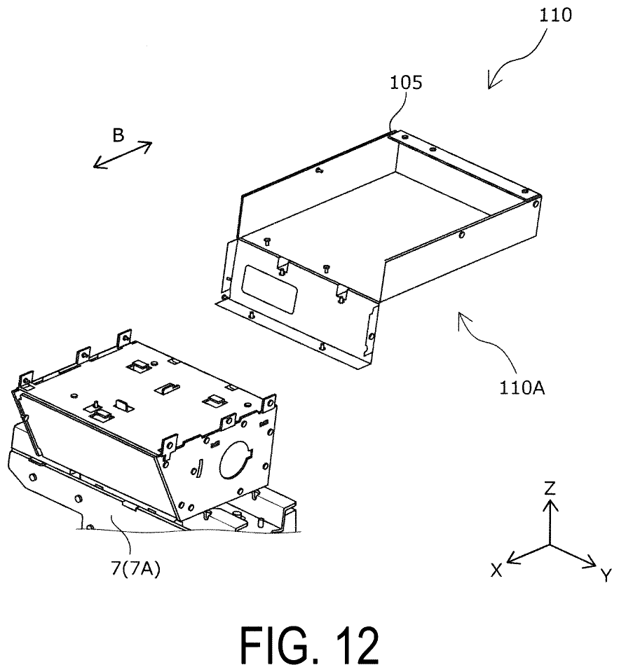

As described above, the printing apparatus 1 according to the embodiment includes the head 5 that performs printing on the media M while moving in the width direction B, the platen 3B that is provided at the position facing the head 5 in a printing range of the head 5 and supports the medium M, the base frame 100 that supports the platen 3B, and a pair of the leg frames 7 that support the base frame 100. Hereinafter, the base frame 100, which is a main portion of the printing apparatus 1 according to the embodiment, will be described below in detail with reference to FIGS. 2 to 13. Note that each of the base frames 100 is formed of a metal plate.

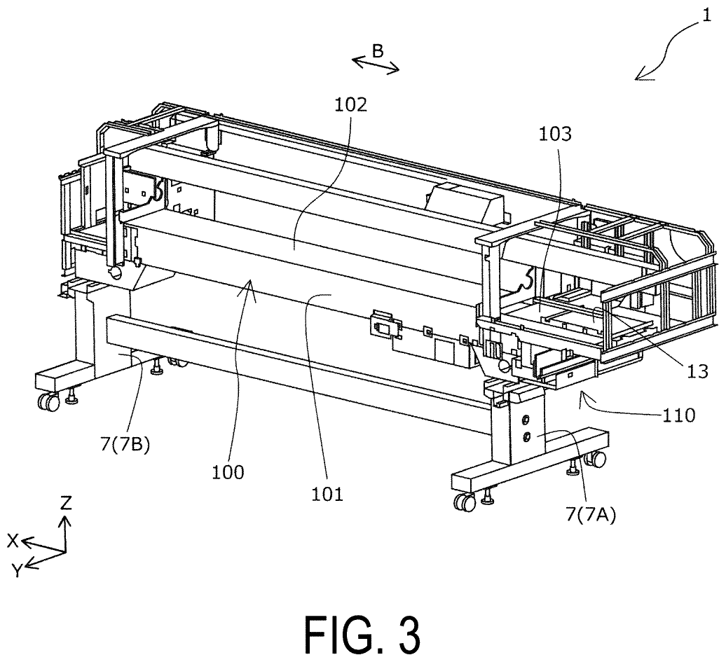

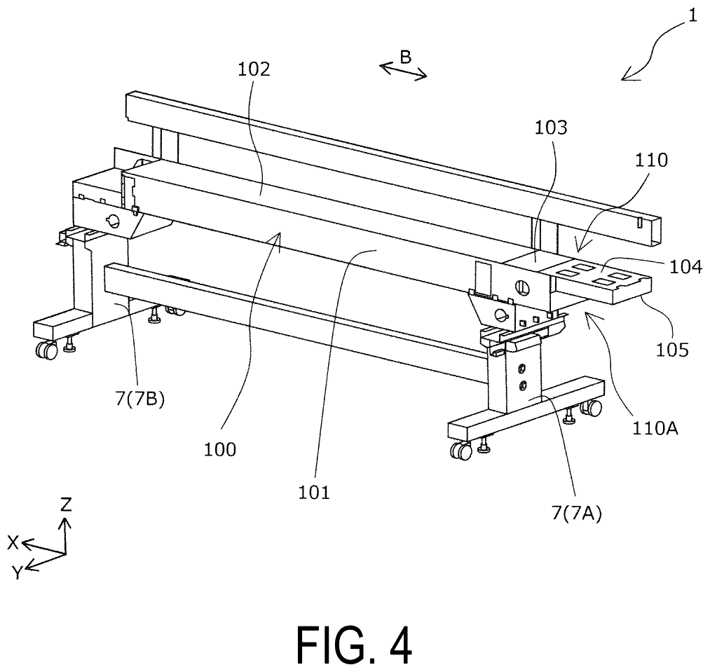

Here, as illustrated in FIGS. 3 and 4, the base frame 100 extends in the width direction B. Further, as illustrated in FIGS. 3 and 4, the leg frames 7 include a leg frame 7A and a leg frame 7B, are provided with an interval therebetween in the width direction B, and can support the base frame 100.

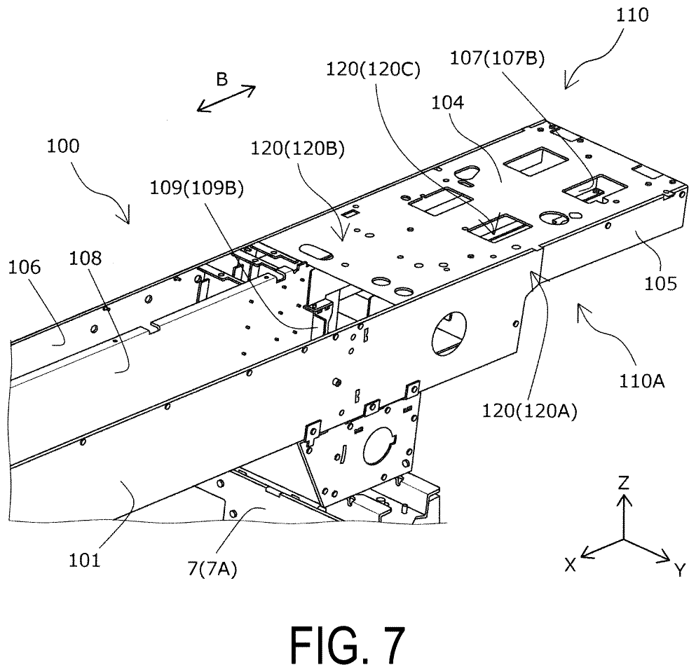

The base frame 100 is illustrated in FIGS. 3 to 10 and includes a frame 101 having a surface on the +Y direction side and a surface on the −Z direction side and extending in the width direction B. Further, as illustrated in FIGS. 3 to 6, the base frame 100 includes a frame 102 that has a surface on the +Z direction side, can be fixed to the frame 101, and extends in the width direction B. Further, as illustrated in FIGS. 7 to 11, the base frame 100 includes a frame 106 that has a surface on the −Y direction side, can be fixed to the frame 101, and extends in the width direction B. Furthermore, as illustrated in FIG. 7, the base frame 100 includes a frame 108 that is provided in a region surrounded by the frame 101, the frame 102, and the frame 106. The frame 101, the frame 102, the frame 106, and the frame 108 are disposed at positions on the −Z direction side of the platen 3B, that is, below the platen 3B.

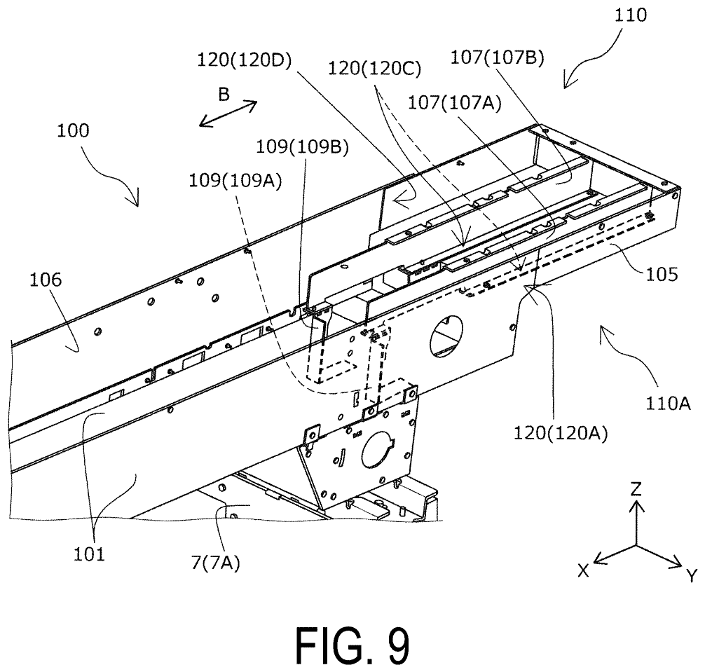

A part of each of the frame 101, the frame 102, the frame 106, and the frame 108 protrudes further to the −X direction side than the leg frame 7A. As illustrated in FIGS. 4 to 10 and the like, a frame 105 having a surface on the +Y direction side, a surface on the −Z direction side, and a surface on the −Y direction side is attached to the frame 101 and the frame 106, at a position further to the −X direction side than each of the frame 101 and the frame 106. Further, as illustrated in FIGS. 4 to 6, a frame 104 that is attached to the frame 102 via the frame 103 is provided on the +Z direction side of the frame 105. A region in which the frame 103 is disposed in the Z-axis direction corresponds to a region in which the frame 102, the frame 103, and the frame 104 overlap each other in the Z-axis direction. Further, frames 107 (a frame 107A and a frame 107B) are provided in a region surrounded by the frame 105 and the frame 104. As illustrated in FIG. 9, the frames 107 are attached to the frame 105, and are also attached to the frame 101 via frames 109 (a frame 109A and a frame 109B).

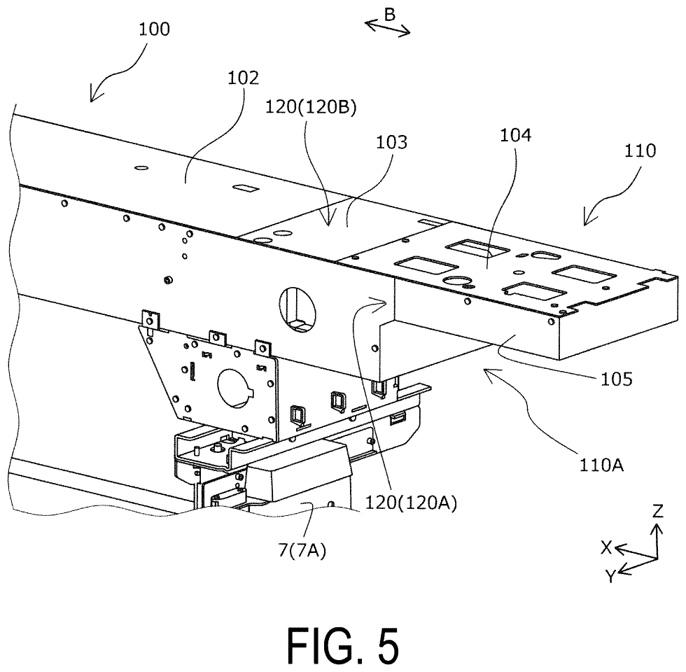

In this way, the base frame 100 protrudes further to the outer side than the leg frame 7A in the width direction B, and a region protruding further to the outer side than the leg frame 7A in the width direction B is a protruding portion 110. As described above, the frame 101 and the frame 105 are attached to the protruding portion 110, but the frame 101 and the frame 105 partially overlap each other in the Y-axis direction as illustrated in FIGS. 5 to 10. Then, a region in which the frame 101 and the frame 105 partially overlap each other in the Y-axis direction constitutes a reinforcing portion 120 (a reinforcing portion 120A).

Further, as illustrated in FIGS. 4 to 6 and the like, the frame 102, the frame 103, and the frame 104 are attached to the protruding portion 110, but the frame 102, the frame 103, and the frame 104 overlap one another in the Z-axis direction in a region in which the frame 103 is disposed. Then, a region in which the frame 102, the frame 103, and the frame 104 overlap one another in the Z-axis direction, which corresponds to the region in which the frame 103 is disposed, constitutes the reinforcing portion 120 (a reinforcing portion 120B).

Further, as illustrated in FIG. 9 and the like, the frame 105 and the frame 107 are attached to the protruding portion 110, and the frame 107 and the frame 101 are attached to each other via the frame 109. Specifically, the frame 105 and the frame 107 partially overlap each other in the Z-axis direction, and the frame 107 and the frame 101 partially overlap each other in the Z-axis direction via the frame 109. Then, a region in which the frame 105 and the frame 107 partially overlap each other in the Z-axis direction and a region in which the frame 107 and the frame 101 partially overlap each other in the Z-axis direction via the frame 109 each constitute the reinforcing portion 120 (a reinforcing portion 120C).

Furthermore, as illustrated in FIGS. 9 to 11, the frame 106 and the frame 105 are attached to the protruding portion 110, but the frame 106 and the frame 105 partially overlap each other in the Y-axis direction. Then, a region in which the frame 106 and the frame 105 partially overlap each other in the Y-axis direction constitutes the reinforcing portion 120 (a reinforcing portion 120D).

As described above, the base frame 100 in the printing apparatus 1 according to the embodiment includes the protruding portion 110 that protrudes further to the outer side than the leg frame 7A in the width direction B, which is the movement direction of the head 5. Then, the protruding portion 110 includes the reinforcing portion 120 in which a plurality of metal plates overlap each other when viewed from the Y-axis direction and the Z-axis direction, which are directions intersecting the width direction B corresponding to the X-axis direction. Note that each of the frames constituting the base frame 100 may be formed of one metal plate having no joints from one end to the other end in the width direction B, and another metal plate may be disposed so as to overlap the reinforcing portion 120.

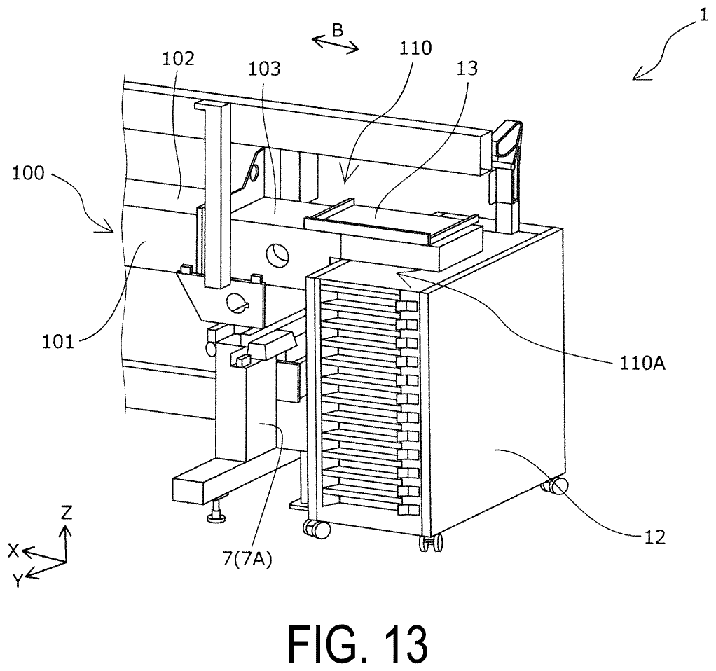

Since the printing apparatus 1 according to the embodiment has such a configuration as described above, it is possible to eliminate the necessity of providing a new constituent member in the periphery of the leg frame 7. For example, it becomes unnecessary to install a reinforcing member at the leg frame 7. Therefore, in the printing apparatus 1 according to the embodiment, a space such as a space below the protruding portion 110 can be effectively utilized, and further, the base frame 100 including the protruding portion 110 can be reinforced. Specifically, the base frame 100 is reinforced by the reinforcing portion 120, and the ink supply unit 12 can be disposed below the protruding portion 110 as illustrated in FIGS. 2 and 13.

Further, as described above, in the printing apparatus 1 according to the embodiment, the protruding portion 110 includes a plurality of the reinforcing portions 120 including the reinforcing portion 120A, the reinforcing portion 120B, the reinforcing portion 120C, and the reinforcing portion 120D. Thus, in the printing apparatus 1 according to the embodiment, the base frame 100 including the protruding portion 110 can be effectively reinforced by the plurality of reinforcing portions 120.

More specifically, as described above, in the printing apparatus 1 according to the embodiment, the reinforcing portion 120A and the reinforcing portion 120D among the reinforcing portions 120 have a configuration in which a plurality of metal plates overlap each other in the Y-axis direction, and the reinforcing portion 120B and the reinforcing portion 120C among the reinforcing portions 120 have a configuration in which a plurality of metal plates overlap each other in the Z-axis direction. As described above, it is particularly preferable that a configuration is adopted in which the plurality of metal plates overlap each other in different directions in at least two of the reinforcing portions 120. With such a configuration, it is possible to reinforce the base frame 100 against stress or the like applied from a plurality of different directions, and the base frame 100 including the protruding portion 110 can be particularly effectively reinforced.

Further, from another point of view, in the printing apparatus 1 according to the embodiment, the protruding portion 110 is formed by joining the plurality of frames constituting the base frame 100 in the width direction B, in other words, by joining the plurality of metal plates in the width direction B. With such a configuration, the reinforcing portion 120 can be constituted without any increase in size. Therefore, as described above, the printing apparatus 1 according to the embodiment can effectively utilize the space such as the space below the protruding portion 110.

Further, as illustrated in FIG. 2, in the printing apparatus 1 according to the embodiment, the pair of leg frames 7 are provided at positions sandwiching the platen 3B when viewed from a direction intersecting the width direction B. Since the printing apparatus 1 according to the embodiment has such a configuration, the entire printing apparatus 1 can be suitably supported by the pair of leg frames 7.

Further, as illustrated in FIGS. 3 and 13, the printing apparatus 1 according to the embodiment includes a maintenance unit 13 that performs maintenance of the head 5. The maintenance unit 13 is disposed at the protruding portion 110. Since the printing apparatus 1 according to the embodiment has such a configuration, the space of the printing apparatus 1 can be effectively utilized, and it is possible to suppress an increase in the size of the printing apparatus 1. Note that the configuration of the maintenance unit 13 is not particularly limited, but a configuration in which a suction mechanism, a wiping mechanism, or the like is provided can be preferably used.

Further, as illustrated in FIGS. 5 to 10, in the printing apparatus 1 according to the embodiment, the shape of the protruding portion 110 further to the inner side (+X direction side) in the width direction B than the reinforcing portion 120A is different from the shape of the protruding portion 110 further to the outer side (−X direction side) in the width direction B than the reinforcing portion 120A. The shape of the protruding portion 110 is not particularly limited. However, by causing the shape of the protruding portion 110 to be different on the inner side and on the outer side of the reinforcing portion 120A, as described above, the space can be efficiently and effectively utilized in accordance with the shape or the like of the other constituent members.

More specifically, as illustrated in FIGS. 5 to 10, in the printing apparatus 1 according to the embodiment, the protruding portion 110 has a spatial shape 110A, which forms a space obtained by cutting out a lower portion (a portion on the −Z direction side) of the reinforcing portion 120A in the upward direction (+Z direction), and the spatial shape 110A is located on the outer side (−X direction side) in the width direction B with respect to the reinforcing portion 120A. Thus, in the printing apparatus 1 according to the embodiment, a wide space can be secured below the protruding portion 110, and the space can be particularly efficiently utilized in accordance with the shape or the like of the other constituent members. Specifically, as illustrated in FIG. 13, the ink supply unit 12 can be efficiently disposed in the space below the protruding portion 110. Note that, if the spatial shape 110A is not provided, it is necessary to increase the height of the entire printing apparatus 1 in order to dispose the ink supplying unit 12, which results in an increase in the size of the apparatus, and an efficient arrangement is not achieved.

In the embodiment, the shape of the protruding portion 110 is formed so as to conform to the outer shape of the ink supply unit 12. Therefore, as illustrated in FIG. 2, when the ink supply unit 12 is disposed, with respect to the printing apparatus 1, at a position at which the ink supply unit 12 is used, the ink supply unit 12 falls within an installation range of the printing apparatus 1, and the installation space is efficiently used. Further, since the shape of the protruding portion 110 is formed so as to conform to the outer shape of the ink supply unit 12, a sense of unity is felt in terms of design, and a sense of visual stability is also generated. Note that even when the shape of the protruding portion 110 is not formed so as to conform to the outer shape of the ink supply unit 12, as long as the ink supply unit 12 is accommodated in the space below the protruding portion 110, the configuration is effective in terms of using the installation space efficiently.

The present disclosure is not limited to the above-described embodiment, and can be realized in various configurations without departing from the spirit of the present disclosure. Further, technical characteristics in the embodiment corresponding to the technical characteristics in each form described in the SUMMARY can be substituted or combined appropriately to solve some or all of the above-described problems, or to achieve some or all of the above-described effects. Further, when the technical characteristics are not described as being essential in the present specification, the technical characteristics can be deleted as appropriate.

What is claimed is:

1. A printing apparatus comprising:
a printing unit configured to perform printing on a medium while moving in a movement direction;
a platen provided at a position facing the printing unit in a printing range of the printing unit and configured to support the medium;
a base frame extending in the movement direction and configured to support the platen; and
a pair of leg frames provided with an interval therebetween in the movement direction and configured to support the base frame, wherein
the base frame includes a protruding portion protruding further to an outer side than the leg frame in the movement direction, and
the protruding portion includes a reinforcing portion constituted by a plurality of metal plates overlapping each other when viewed from a direction intersecting the movement direction.

2. The printing apparatus according to claim 1, wherein
a shape of the protruding portion on an inner side of the reinforcing portion in the movement direction is different from a shape of the protruding portion on an outer side of the reinforcing portion in the movement direction.

3. The printing apparatus according to claim 2, wherein
the protruding portion has a spatial shape forming a space obtained by cutting out a lower portion of the protruding portion in an upward direction, the spatial shape being located on an outer side of the reinforcing portion in the movement direction.

4. The printing apparatus according to claim 2, wherein
the protruding portion is constituted by joining the plurality of metal plates in the movement direction.

5. The printing apparatus according to claim 1, wherein
the pair of leg frames are provided at positions sandwiching the platen when viewed from a direction intersecting the movement direction.

6. The printing apparatus according to claim 1, comprising
a maintenance unit configured to perform maintenance of the printing unit, wherein
the maintenance unit is disposed at the protruding portion.

7. The printing apparatus according to claim 1, wherein
the protruding portion includes a plurality of the reinforcing portions.

8. The printing apparatus according to claim 7, wherein
the plurality of metal plates overlap each other in different directions in at least two of the plurality of reinforcing portions.
